(19) United States
(12) Patent Application Publication
(10) Pub. No.: US 2008/0196973 A1
(43) Pub. Date: Aug. 21, 2008

(54) LADDER LEVELLING APPARATUS

(75) Inventor: Abraham Gomez Lopez, Louisville, KY (US)

Correspondence Address: EGBERT LAW OFFICES, 412 MAIN STREET, 7TH FLOOR, HOUSTON, TX, 77002, US

(73) Assignee: Louisville Ladder Group LLC, Louisville, KY (US)

(21) Appl. No.: 11/676,645

(22) Filed: Feb. 20, 2007

(51) Int. Cl. E06C 7/44

(52) U.S. Cl. 182/200

(57) ABSTRACT

A ladder levelling apparatus includes a ladder having a pair of side rails in spaced relation with a cross member extending the pair of side rails, a bracket affixed to the cross member, and a bar slidably received within the bracket so as to have ends of the bar respectively extending outwardly beyond the pair of side rails. A first foot and a second foot are respectively affixed to the ends of the bar. The bar is arch-shaped such that the ends are positioned below the bottom of the pair of side rails when the bar is centered relative to the side rails. A receptacle extends from the bracket suitable for receiving the bar therein.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to devices for the levelling of ladders when the ladders are used on uneven underlying surfaces. More particularly, the present invention relates to the use of such ladder levelling devices on step ladders. More particularly, the present invention relates to ladder levelling devices that can be easily stowed when not in use.

2. Description of Related Art Including Information Disclosed Under 37 CFR 1.97 and 37 CFR 1.98.

Ladders frequently must be used on sloped or irregular surfaces. For example, ladders used on the exteriors of buildings often encounter slopped ground. On the interior of buildings, stairs present difficulties for ordinary ladders. In both circumstances, the bottom of the side rails may not contact the ground or floor simultaneously. If the ladder is adjusted to conform to the ground or floor, then it is possibly unstable.

For the most part, conventional step ladders are used on relatively level surfaces. However, when the use of the step ladders is on an uneven or irregular surface, it is desirable to have some type of ladder levelling device so as to enhance the stability of the ladder. If the ladder levelling device is permanently incorporated on the step ladder, then there may be many circumstances when the use of such a ladder levelling device is inappropriate. As such, it is desirable to have a ladder levelling device that can be easily stowed on the ladder when not in use and stowed so as to not interfere with the conventional operation of the step ladder.

In the past, various patents have issued relating to ladder levelling devices. For example, U.S. Pat. No. 4,128,139, issued on Dec. 5, 1978 to J. E. Cook, teaches an automatic levelling and locking ladder. Each leg of the base has a rack and pinion assembly. The pinions are interconnected by a shaft. A tab interfering with the pinions serves to prevent their rotation as weight is placed on the ladder. An automatic lock is provided to retain the tab in interfering engagement subsequent to the weight being removed so as to increase the operational safety of the ladder.

U.S. Pat. No. 4,304,318, issued on Dec. 8, 1981 to A. E. Webb, describes a ladder levelling device used in combination with a ladder on an inclined ground surface. The levelling device is placed under one leg of the ladder while the other leg rests on the ground surface or some other support. The ladder levelling device comprises a triangular, inclined platform including an open cavity area defined in its bottom side.

U.S. Pat. No. 4,671,383, issued on Jun. 9, 1987 to Y. W. Huang, discloses a ladder leveller that includes an adjustable base having two adaptors suitable for receiving the ladder feet and a pair of telescopic legs respectively fixed under the two adaptors. Both the telescopic legs can be optionally adjusted in height so as to allow the base and the ladder feet riding on the base to stand on a irregular floor surface in a stable manner.

U.S. Pat. No. 4,699,247, issued Oct. 13, 9187 to J. B. Clarke, provides a device for supporting simultaneously the bottom ends of both stiles of a ladder from sloping ground such that the rungs of the ladder are arranged horizontally. The device comprises a reversible triangular platform which is supported from the ground by three feet. One of the feet spaces the respective corner of the platform at a greater height above the ground than the other two feet.

U.S. Pat. No. 4,993,514, issued on Feb. 19, 1991 to W. H. Ferguson, discloses a ladder levelling device that includes a carrier structure capable of attachment to a ladder so as to carry the feet of the ladder. The carrier structure incorporates a fixedly mounted first interconnect device, ground-engaging feet devices, and a linkage arrangement connected to the ground-engaging feet. A second interconnection device is provided which is capable of releasably interconnecting with the first interconnect device to enable verticality of a ladder when the ground-engaging devices engage an inclined surface.

U.S. Pat. No. 5,007,503, issued on Apr. 16, 1991 to W. Sturm, teaches an automatic levelling device for attachment to a ladder so as to allow the ladder to be used on an uneven supporting surface. The levelling device includes a downwardly opened U-shaped tubular member which guidably supports therein a ball chain connecting element. Extendable legs are slidable within the open ends of the tubular member and are attached to opposite ends of the connecting element. A lock is connected to the tubular member and is adapted to cooperate with the ball chain to provide positive locking of the chain when the extendable legs are in the proper position to maintain the ladder in a vertical orientation.

U.S. Pat. No. 5,139,109, issued on Aug. 18, 1992 to J. B. Clarke, provides a device for supporting the lower ends of ladder stiles on unlevel ground. This device comprises a flat flexible mat having, at one end, a ramp portion. One stile rests on the flat mat and the other rests, at an appropriate height on the ramp portion.

U.S. Pat. No. 5,335,754, issued on Aug. 9, 1994 to R. Gibson, shows a self-levelling ladder with a pair of elongated sleeves slidably embracing the bottom of the side rails of the ladder. Each sleeve has opposite sides. One of the sides has a plurality of spaced-apart teeth therein. A pawl is connected to each of the rails so as to engage one of the teeth on one sleeve.

U.S. Pat. No. 5,845,744, issued on Dec. 8, 1998 to H. A. E. Beck, discloses a ladder levelling device that includes a housing, a telescopic member and a lever. The lever is positioned within an interior cavity of the telescopic member. The lever has a mounting end and a gripping end. The mounting end of the lever is pivotally mounted at a ground-engaging end of the telescopic member. The gripping end of the lever is accessible through a lever access opening at a handgrip end of the telescopic member. A locking pin is carried by the lever. The lever is pivotable between a locking position and a release position. In the locking position, the locking pin carried by the lever extends through an aperture through the telescopic member and engages one of a plurality of apertures in the housing.

U.S. Pat. No. 6,336,521, issued on Jan. 8, 2002 to M. C. Dennis, teaches a ladder levelling device which utilizes opposed locking brackets so that adjustments can be made by releasing a locking plate on a single bracket.

U.S. Pat. No. 6,450,292, issued on Sep. 17, 2002 to L. R. Sheffield, shows a ladder levelling device that can be operated by a person's foot. A stile extender is inserted into the hollow stile or is removably attached to side of the stile of ladder. An internal telescopic extender and ratchet mechanism can rock about a pivot in the housing to disengage the opposing teeth

It is an object of the present invention to provide an apparatus which allows a step ladder to be used on an uneven or irregular surface.

It is another object of the present invention to provide a ladder levelling apparatus that can easily stowed on the ladder when not in use.

It is a further object of the present invention to provide a ladder levelling device which is easy to deploy and implement.

It is still a further object of the present invention to provide a ladder levelling device which is safe, convenient and relatively inexpensive.

These and other objects and advantages of the present invention will become apparent from a reading of the attached specification and appended claims.

### BRIEF SUMMARY OF THE INVENTION

The present invention is a ladder levelling apparatus that comprises a ladder having a first ladder section and a second ladder section hingedly connected together at an upper end thereof. The first ladder section has a pair of side rails in spaced parallel relation with a cross member extending therebetween. A bar is pivotally connected to the cross-member. The bar has ends respectively extending outwardly beyond the pair of side rails. In particular, the bar is pivotally mounted to the cross member through the use of a bracket that is affixed to the cross member. The bar is slidably received within the bracket.

So as to facilitate the easy stowing of the bar, the bracket has a receptacle extending therefrom. This receptacle is suitable for selectively receiving the bar therein. The receptacle is pivotally mounted to the bracket. The receptacle has a slot therein. The slot has a size suitable for receiving the bar therein. When the bar is not in use, it can be simply placed through the slot of the receptacle and pivoted upwardly so as to reside adjacent to the steps on an unused ladder section.

The bar has a first foot affixed to one of the ends of the bar, and a second foot affixed to the other of the ends of the bar. Each of these feet has a flat bottom surface suitable for contacting an underlying surface. The first and second feet are removably affixed to the respective ends of the bar.

The bar has an arch shape such that the ends of the bar are positioned below a level of a bottom of the pair of side rails when the bar is centered relative to the pair of side rails. Each of the pair of side rails has a slot formed adjacent to the bottom thereof. The bar extends through these slots. The bar will have a length approximately equal to a height of the ladder.

In the preferred embodiment of the present invention, the ladder is a step ladder.

### BRIEF DESCRIPTION OF THE SEVERAL VIEWS OF THE DRAWINGS

FIG. 1 is a perspective view showing the ladder levelling apparatus of the present invention.

FIG. 2 is a side elevational view showing the application of the ladder levelling apparatus of the present invention to an uneven underlying surface.

FIG. 3 is a side elevational view showing the ladder levelling apparatus of the present invention in a stowed position.

### DETAILED DESCRIPTION OF THE INVENTION

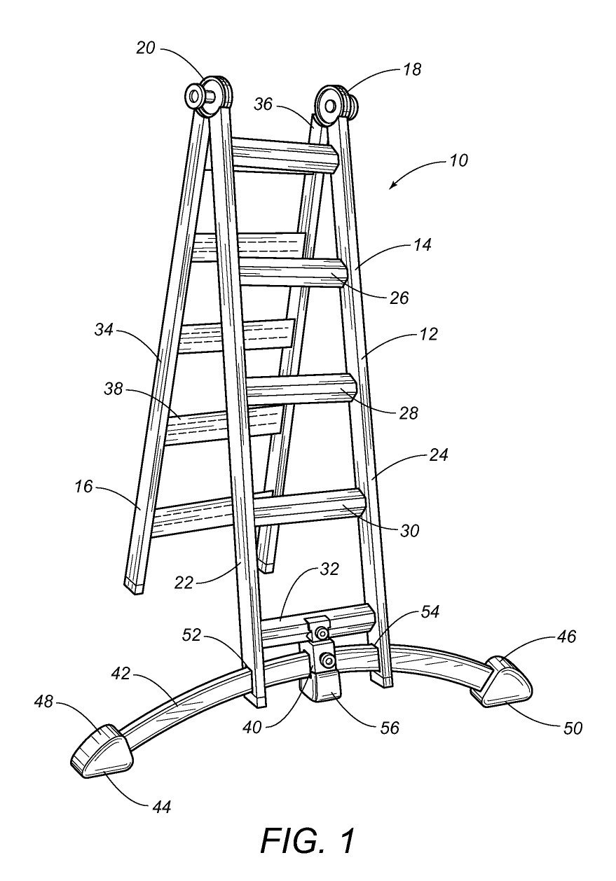

Referring to FIG. 1, there is shown the ladder levelling apparatus 10 in accordance with the preferred embodiment of the present invention. The ladder levelling apparatus 10 includes a ladder 12 having a first ladder section 14 and a second ladder section 16. The first ladder section 14 is connected by hinges 18 and 20 to the second ladder section 16. The first ladder section 14 has a first side rail 22 and a second side rail 24. The first side rail 22 is in spaced parallel relationship to the second side rail 24. A plurality of cross members 26, 28, 30 and 32 extend transversely between the first side rail 22 and the second side rail 24. Similarly, the second ladder section 16 has a first side rail 34 and a second side rail 36 with a plurality of cross members 38 extending therebetween.

Importantly, in the present invention, a bracket 40 is affixed to the cross member 32 generally centrally between the first side rail 22 and the second side rail 24. A bar 42 extends through the bracket 40 so as to have first end 44 and a second end 46 extending beyond the respective side rails 22 and 24. A slot is formed in the bracket 40 so as to allow the bar 42 to slide from one side to the other therethrough. A first foot 48 is affixed to the end 44 of bar 42. A second foot 50 is affixed to the end 46 of bar 42. Each of the feet 48 and 50 are removably affixed to the respective ends 44 and 46 of bar 42. A slot 52 is formed in the side rail 22 generally adjacent to the bottom of the side rail 22. A slot 54 is formed in the side rail 24 generally adjacent to the bottom of the side rail 24. The bar 42 extends through each of the slots 52 and 54.

The bracket 40 has a receptacle 56 extending therefrom. This receptacle 56 is suitable for selectively receiving the bar 42 therein. The receptacle 56 is pivotally connected to the bracket 40. In particular, the receptacle 56 has a slot therethrough with a size suitable for receiving the bar therein. When the self-levelling bar 42 is not deployed, then it is simple to remove the feet 44 and 50 from the ends 44 and 46 of the bar 42, to slide the bar 42 outwardly through the slots 52 and 54 and through the slot associated with the bracket 40. The bar 42 can then slide through the slot associated with the receptacle 56 and rotated so as to be stowed in the manner illustrated in FIG. 3.

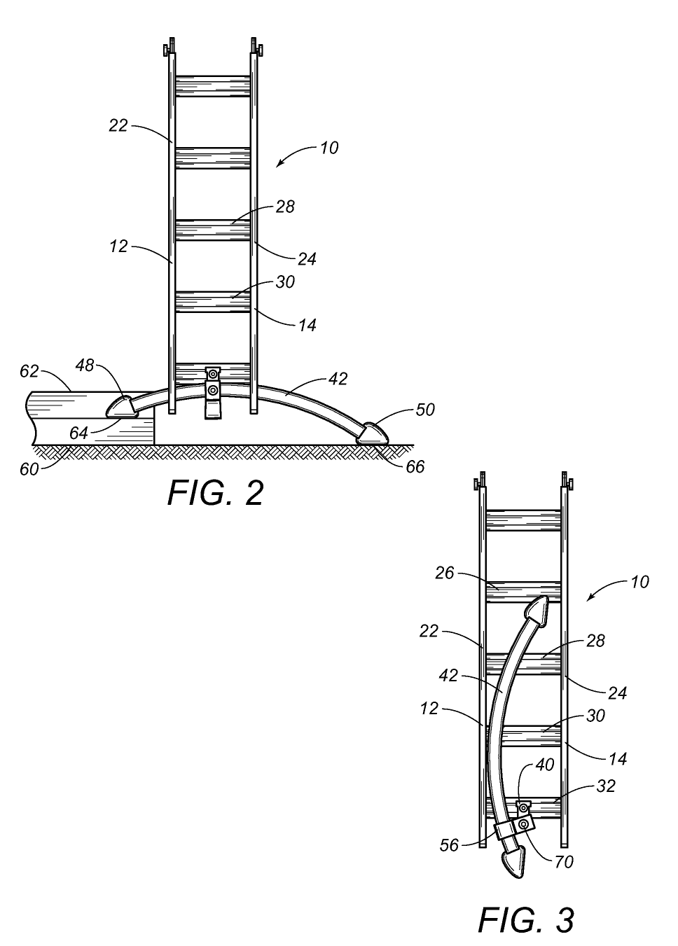

FIG. 2 illustrates how the ladder levelling apparatus 10 functions so as to allow the ladder 12 to be utilized on an uneven underlying surface 60. In FIG. 2, the uneven underlying surface 60 includes a step 62. The foot 48 at the end of bar 42 will have a flat surface 64 resting upon the top of the step 62 of underlying surface 60. The foot 50 at the opposite end of bar 42 will have a flat underlying surface 66 that rests flat on the earth. The bar 42 has been moved through the slot of bracket 40 such that the bar 42 has a shorter length extending outwardly of the side rail 22 than the length of the bar 42 extending outwardly of the side rail 24. As such, the present invention allows the position of the ladder to be suitably adapted to the underlying surface. The ladder 12 is supported in a secure and positive manner by the placement of the feet 48 and 50 in the illustrated positions.

Since the bar 42 has an arch shape, the sliding of the bar 42 through the slot associated with bracket 40 allows the bar 42, along with the associated feet 48 and 50, to be adjusted to various types of irregular surfaces. With reference to FIG. 1, the flat bottom surfaces 64 and 66 of respective feet 48 and 50 will extend below the bottom of the ladder 12 when the bar 42 is generally centered between the side rails 22 and 24. Since the feet 48 and 50 extend outwardly a substantial distance from the side rails 22 and 24, respectively, the base of the ladder 12 is maintained in a very stable orientation. The extension of the bar 42 through the respective slots 52 and 54 at the bottom of the side rails 22 and 24, respectively, further enhances the stability of the ladder 12 when the bar 42 is adapted to the irregular underlying surface.

In FIG. 3, the levelling apparatus 10 is illustrated with the bar 42 in a stowed position adjacent to the cross members 26, 28, 30 and 32 and between the side rails 22 and 24 of ladder 12. Importantly, it can be seen that the receptacle 56 has received the bar 42 therein. The receptacle 56 is connected by a pivot 70 to the bracket 40. The receptacle 56 has a slot therein which can be open at one side of the receptacle 56 so as to allow the bar 42 to be easily inserted therein. Alternatively, the slot can be closed such that the bar 42 can be threaded through the slot.

In the arrangement of FIG. 3, the second ladder section 16 is folded about hinges 18 and 20 so as to reside against the first ladder section 14. As such, the ladder 12 is in a conventional folded position for stowage. Since the bar 42 resides generally flat against the cross members 26, 28, 30 and 32, the bar 42, along with the associated feet 48 and 50, will occupy a minimum of space. As such, the apparatus 10 of the present invention can be easily stored when not in use. It can be seen that the bar 42 has a height which is approximately equal to the height of the ladder 12. Similarly, the curvature associated with the arch shape of the bar 42 will allow the bar 42 to be confined between the side rails 22 and 24 when the bar 42 is in its stowed position.

If desired, the second ladder section 16 can be hingedly pivoted outwardly from the first ladder section in the manner of FIG. 1. If it is not necessary to deploy the bar 42 of the self-levelling apparatus 10, then the user can simply utilize the cross members 38 on the second ladder section 16 while the bar 42 resides in its stowed position.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. An apparatus comprising:
a ladder having a first ladder section and a second ladder section hingedly connected together at an upper end thereof, said first ladder section having a pair of side rails in spaced parallel relationship with a cross member extending between said pair of side rails; and
a bar pivotally mounted to said cross-member, said bar having ends respectively extending outwardly beyond said pair of side rails.

2. The apparatus of claim 1, further comprising:
a bracket affixed to said cross-member, said bar being slidably received within said bracket.

3. The apparatus of claim 2, said bracket having a receptacle extending therefrom, said receptacle suitable for selectively receiving said bar therein.

4. The apparatus of claim 3, said receptacle being pivotally mounted to said bracket. The apparatus of claim 3, said receptacle having a slot therein, said slot having a size suitable for receiving the bar therein.

6. The apparatus of claim 1, further comprising:
a first foot affixed to one of said ends of said bar; and
a second foot affixed to an opposite end of said ends of said bar.

7. The apparatus of claim 6, each of said first and second feet having a flat bottom surface suitable for contacting an underlying surface.

8. The apparatus of claim 6, each of said first and second feet being respectively removably affixed to said ends of said bar.

9. The apparatus of claim 1, said bar being slidably mounted to an cross member.

10. The apparatus of claim 9, said bar being arch-shaped such that said ends are positioned below a level of a bottom of said pair of side rails when said bar is centered relative to said pair of side rails.

11. The apparatus of claim 1, each of said pair of side rails having a slot formed adjacent a bottom thereof, said bar extending through the slots.

12. The apparatus of claim 1, said ladder being a step ladder.

13. The apparatus of claim 1, said bar having a length approximately equal to a height of said ladder.

14. An apparatus comprising:
a ladder having a pair of side rails in spaced parallel relation with a cross member extending between said pair of side rails;
a bracket affixed to said cross member; and
a bar received by said bracket, said bar having ends respectively extending outwardly beyond said pair of side rails.

15. The apparatus of claim 14, said bracket having a slot formed therein, said bar slidably extending through said slot.

16. The apparatus of claim 14, said bracket having a receptacle extending therefrom, said receptacle suitable for selectively receiving said bar therein, said receptacle being pivotally mounted to said bracket, said receptacle having a slot therein, said slot having a size suitable for receiving the bar therein.

17. The apparatus of claim 14, further comprising:
a first foot affixed to one of said ends of said bar; and
a second foot affixed to an opposite end of said ends of said bar.

18. The apparatus of claim 15, said bar being arch-shaped such that said ends are positioned below a level of a bottom of said pair of side rails when said bar is centered relative to and pair of side rails.

19. The apparatus of claim 15, each of said pair of side rails having a slot formed adjacent a bottom thereof, said bar extending through the slots, each of the slots having a length which is greater than a width of the bar.

20. The apparatus of claim 14, said bar having a length approximately equal to a height of said ladder.
